(19) United States
(12) Patent Application Publication
(10) Pub. No.: US 2018/0213206 A1
(43) Pub. Date: Jul. 26, 2018

(54) MODIFYING ILLUMINATION PROFILE FOR LIGHT SOURCE

(71) Applicant: Microsoft Technology Licensing, LLC, Redmond, WA (US)

(72) Inventors: Raymond Kirk Price, Redmond, WA (US); Ravi Kiran Nalla, San Jose, CA (US)

(73) Assignee: Microsoft Technology Licensing, LLC, Redmond, WA (US)

(21) Appl. No.: 15/417,078

(22) Filed: Jan. 26, 2017

(51) Int. Cl. H04N 13/02; F21V 5/04; F21V 5/00; G02B 27/42

(52) U.S. Cl. CPC H04N 13/0253; F21V 5/04; F21Y 2115/10; G02B 27/425; H04N 13/0296; F21V 5/007

(57) ABSTRACT

Examples are disclosed that relate to modifying an illumination profile of an illumination source. An example illumination system includes an illumination source configured to output light according to an illumination profile representing a distribution of light intensity across a field of view of the illumination system, an image sensor configured to detect light output by the illumination source and reflected off of one or more objects in an environment of the illumination system, and an illumination optic configured to direct light from the illumination source outward into the environment, the illumination optic structured to form a modified illumination profile having a modified distribution of illumination intensity, the modified distribution of intensity including a first intensity at a normal angle relative to the illumination source and a second intensity at other angles relative to the illumination source, the first intensity being lower than the second intensity.

### BACKGROUND

Image capture devices, such as those used for depth sensing and image recognition, may utilize one or more light sources to illuminate an environment for imaging.

### SUMMARY

Examples are disclosed that relate to modifying an illumination profile of an illumination source to provide a selected level of uniformity of light intensity across a field of view of an image sensor associated with the illumination source. An example illumination system includes an illumination source configured to output light according to an illumination profile representing a distribution of light intensity across a field of view of the illumination system, an image sensor configured to detect light output by the illumination source and reflected off of one or more objects in an environment of the illumination system, and an illumination optic configured to direct light from the illumination source outward into the environment, the illumination optic structured to form a modified illumination profile having a modified distribution of illumination intensity, the modified distribution of intensity including a first intensity at a normal angle relative to the illumination source and a second intensity at other angles relative to the illumination source, the first intensity being lower than the second intensity.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example image capture environment.

FIG. 2 shows an example plot of sources of optical non-uniformity in imaging systems.

FIG. 3 shows an example illumination source.

FIGS. 4A and 4B show side and front views of another example illumination source.

FIG. 5 shows an example plot of an illumination intensity profile for an illumination source of FIG. 3.

FIG. 6 shows an example plot of a relationship between an illumination profile for an illumination source including the illumination optic of FIG. 3 and the total optical losses of an associated imaging system.

FIG. 7 shows a flow diagram illustrating an example method of manufacturing an illumination optic.

FIG. 8 is a block diagram of an example computing system.

### DETAILED DESCRIPTION

The imaging quality of an image capture system may depend on various factors, such as the size of an image sensor, image optics used in the system, and environmental conditions, such as ambient light. In order to increase an amount of light in the environment that is reflected off of objects in the environment and detected by an image sensor, many image capture devices include illumination sources to output light outward toward the environment. However, light from such illumination sources experiences optical losses along the path from the illumination source, to the environment, and back to the image sensor. These optical losses reduce the amount of light that eventually reaches the image sensor to form the captured image and can result in an uneven angular intensity distribution of light received at the sensor.

Accordingly, examples are disclosed that relate to an illumination optic configured to modify an illumination profile of light output by an illumination source. The modified distribution of intensity may have a lower intensity at a normal angle relative to the illumination source and a higher intensity at angles away from the normal to provide a selected level of light intensity uniformity across a field of view of the image capture device.

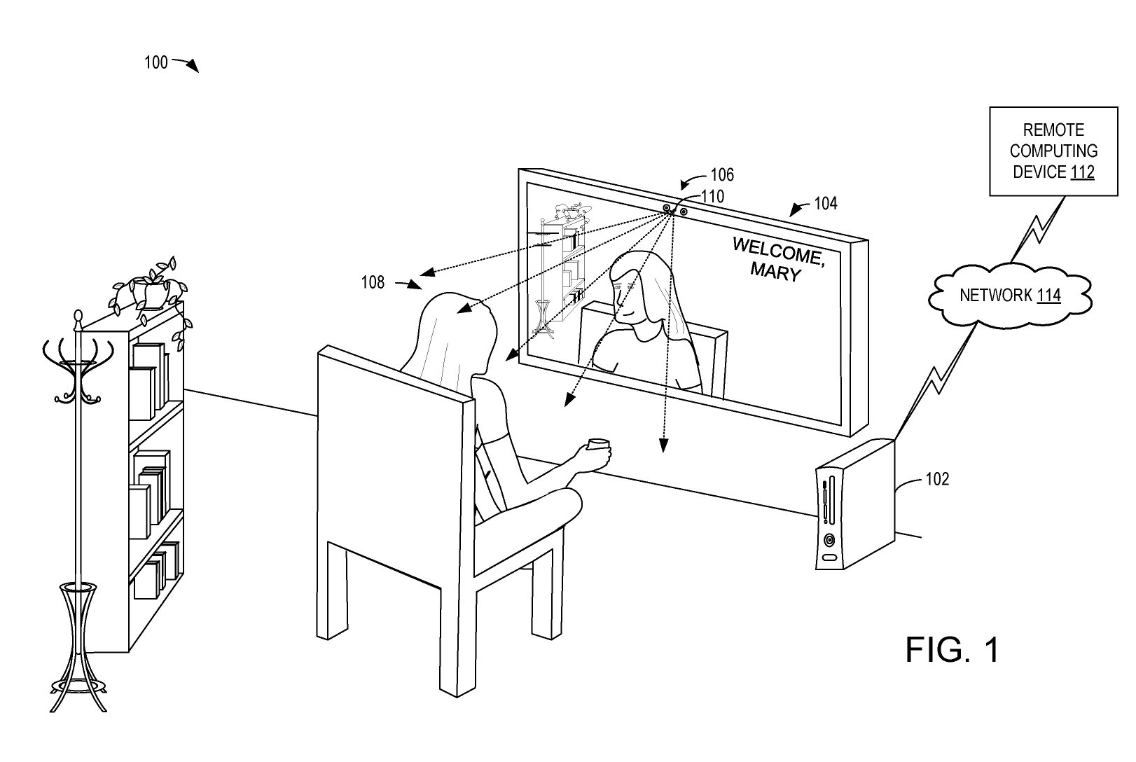

FIG. 1 shows an example image capture environment 100. Image capture environment 100 includes a computing device 102 that may be used to play a variety of different games, play one or more different media types, and/or control or manipulate non-game applications and/or operating systems. In the depicted example, computing device 102 takes the form of a video game console, but may take any other suitable form in other implementations, such as a desktop computer, a laptop computer, a mobile phone, and a tablet. FIG. 1 also shows a display device 104, such as a television or a computer monitor, which may be used to present output from computing device 102. An imaging device 106 is also shown as incorporated into the display device 104. The imaging device may be used to image a scene including a user 108 and/or other objects in the room. While illustrated as a room in FIG. 1, it will be appreciated that environment 100 may comprise any suitable physical location. Further, in other examples, the imaging device 106 may comprise a peripheral device, rather than being integrated into a computing device.

The imaging device 106 may capture one or more images and/or form a live video feed of the scene and send corresponding image data to a computing device 102 via the one or more interfaces. In order to capture information about the scene, the imaging device 106 may include any suitable sensors. For example, the imaging device 106 may include a two-dimensional camera (e.g., an RGB or IR-sensitive camera), a depth camera system (e.g., a time-of-flight and/or structured light depth camera), and/or a stereo camera arrangement.

The computing device 102 may utilize captured images for any of a variety of purposes. For example, the computing device 102 may analyze captured images to identify and authenticate users of the computing device in a login process, to detect gesture inputs, and/or to conduct videoconferencing. Such authentication may be performed locally, or captured images may be sent to a remote computing device 112 via a network 114 for authentication, gesture detection, and/or other functionalities.

During image capture, illumination light from one or more illumination sources 110 (visible and/or infrared) may be output to illuminate a field of view of the imaging device 106 to help image the environment more readily. However, as mentioned above losses, in the round trip transmission path of the illumination light from the illumination source, to the environment/objects, and back to the image sensor may affect imaging quality.

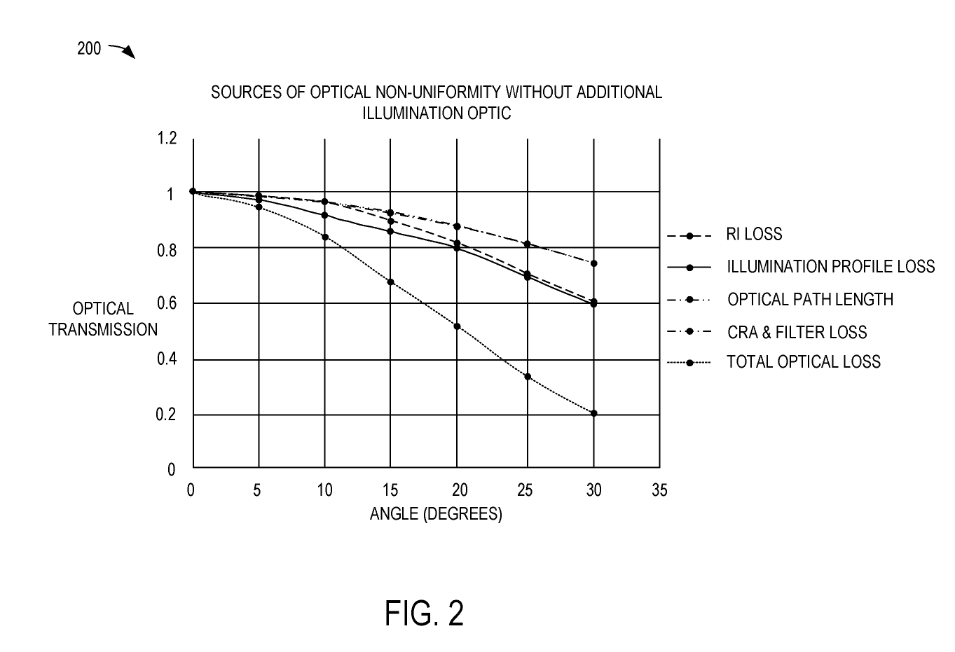

FIG. 2 shows an example graph 200 of various sources of optical non-uniformity in imaging systems. As shown in FIG. 2, light output at 0 degrees (e.g., normal to and straight out of the illumination source) experiences a baseline amount of optical losses. However, light output at this angle only illuminates a very small region of an environment and may not be sufficient for performing an image-related action. For example, light output at such an angle may illuminate a small region of a user's face, which may not provide enough information identify the user and/or differentiate between multiple users.

Optical losses become more apparent for illumination light output from the illumination source at larger angles. A total optical loss for an illumination source may be based, for example, on relative illumination (RI) loss, illumination profile loss, total optical path length, and chief ray angle (CRA) and filter loss. Also there is often optical loss due to visors, cover glass, etc. that are placed to protect the imaging lens and illuminator optic. RI loss, or lens shading, refers to light fall-off observed toward the edges of an image due to entrance angle on lens, geometry size, f-number of the lens, and other factors. Illumination profile loss refers to losses due to roll-off at the edges of an illumination profile for a given light source. Optical path length loss refers to the round trip optical path losses due to the illumination intensity profile of the light source, which typically falls off with angle. CRA and filter loss refers to losses due to exceeding an angle of acceptance for pixels of an image sensor, and losses due to filters applied to an image sensor, through which illumination light passes (e.g., the center wavelength of the passband experiences a blue shift with light angle incident on a narrowband filter). Each of these losses may contribute to a loss in uniformity across a field of view of an image sensor. Optical losses for illumination light in certain regions of a field of view of the image sensor may result in lower image quality in those regions (e.g., fewer photons reaching the sensor resulting in a darkened image, lower resolution, and/or other image quality reductions relative to other regions of the image sensor) due to a difference in light intensity across the field of view.

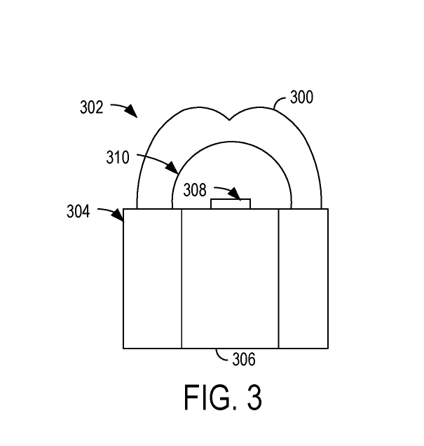

In order to compensate for the total round trip optical loss and provide a more uniform distribution of light intensity across the field of view of an image sensor, an illumination optic may be positioned over an LED illumination source. An example illumination optic 300 is illustrated in FIG. 3, positioned over an illumination source 302, such as an LED device. A cross-sectional view of illumination source 302 is illustrated in FIG. 3 as including an outer package 304 that houses a thermal heatsink 306, an illumination chip (e.g., an LED chip) 308 configured to output illumination light, and control components and/or interfaces (not shown) for the illumination chip 308. The outer package may also include a structure for mounting a lens 310 over the illumination chip 308. In the illustrated example, the lens 310 comprises a spherical lens configured to produce a radially symmetric illumination profile. Such a profile experiences roll-off at the edges of the field of illumination.

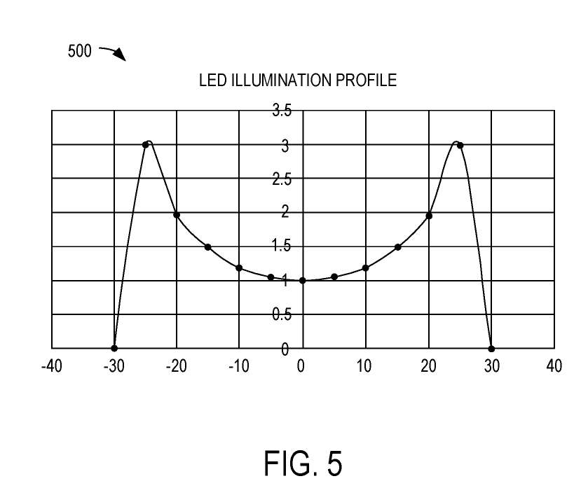

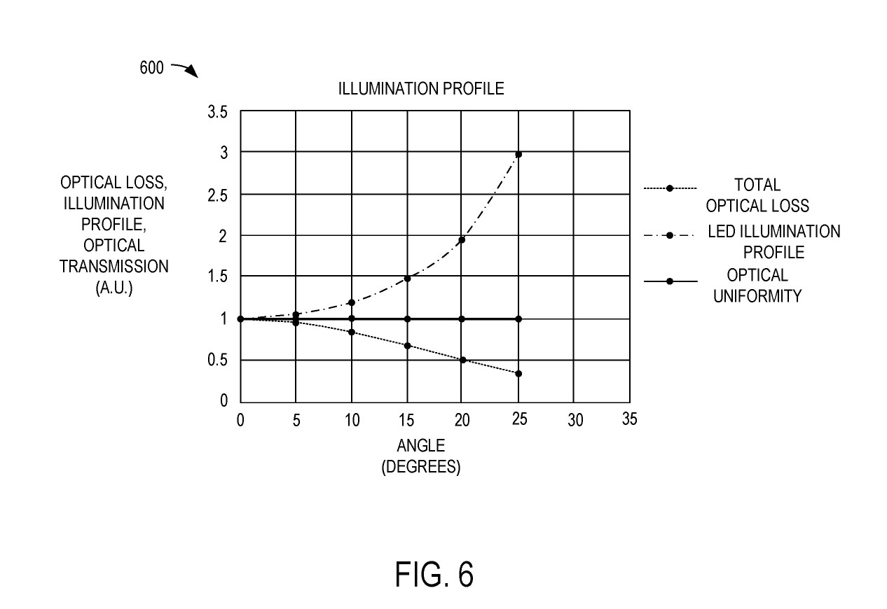

The depicted illumination optic 300 is positioned over the lens 310, and takes the form of a freeform doublet lens configured to create a square or rectangular bimodal illumination profile. An example of such an illumination profile is illustrated in FIGS. 5 and 6 and discussed below.

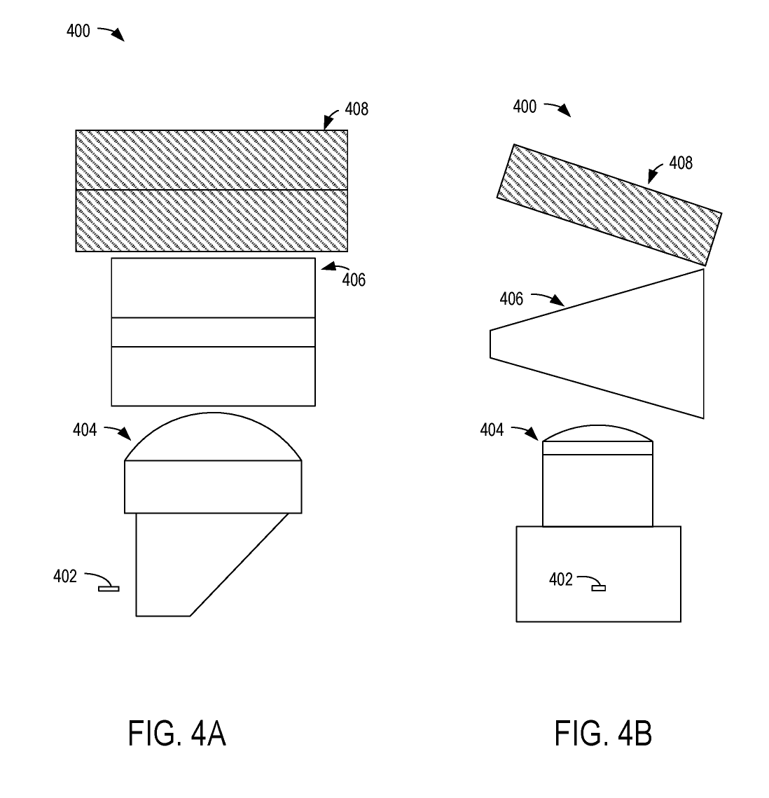

FIGS. 4A and 4B show another example configuration for an illumination optic. FIG. 4A shows a side view of an illumination optic 400, while FIG. 4B shows a front view of the illumination optic 400. A laser illuminator 402 is shown providing light to an optical configuration 404 (e.g., a lens). The laser illuminator 402 may comprise a single mode laser diode or a multimode diode laser. The laser illuminator 402 outputs light (e.g., via optical configuration 404) toward a tuning and/or collimating optic 406 (e.g., a collimator), which in turn provides collimated light to a diffuser and/or diffractive optical element 408 to provide an modified illumination pattern. When a multimode and/or broad area diode laser is used, then a microlens array may be used to define the modified illumination pattern, as an example. When a single mode diode laser is used, a diffractive optical element may be used to define the modified illumination pattern, as an example. The optical arrangement in either example comprises a diode laser, followed by a collimator, followed by a diffuser or diffractive optical element.

Turning now to FIG. 5 a modified illumination profile is shown for an illumination optic, such as illumination optic 300 of FIG. 3 and/or illumination optic 400 of FIGS. 4A and 4B. The peaks of the bimodal illumination profile 500 correspond to corners of a rectangular cross sectional output for the illumination source, thereby corresonding to a geometry of the image sensor. In other embodiments, where the lens image circle is inscribed in the sensor, a circular illumination profile is matched to the circular sensor field of view. Next referring to FIG. 6, graph 600 shows the relationship between the illumination profile provided by illumination optic 300 and the total optical losses experienced by light transmitted by the illumination source. As illustrated, the illumination profile resulting from the use of the illumination optic 300 compensates for the total optical losses, resulting in a suitably uniform distribution of light intensity for light output at angles ranging from 0 to 25 degrees relative to a normal direction of the illumination source.

The illumination profile achieved by positioning the illumination optic 300 over the illumination source 302 may be tailored for different optical systems. For example, a wide-angle image capture device may have an illumination optic configured to provide at least 10-15% uniformity in illumination intensity across a field of view of the image sensor. Other image capture devices may have an illumination optic configured to provide at least 30% uniformity in illumination intensity across a field of view of the image sensor. In some examples, the illumination optic may be configured to compensate for at least half of the total optical losses for the imaging system, in order to provide the selected level of uniformity.

In other examples, an optical diffuser that uses geometric optics may provide additional illumination to the high angles. In yet other examples, a Diffractive Optical Element may be used to provide the increased illumination to the high angles.

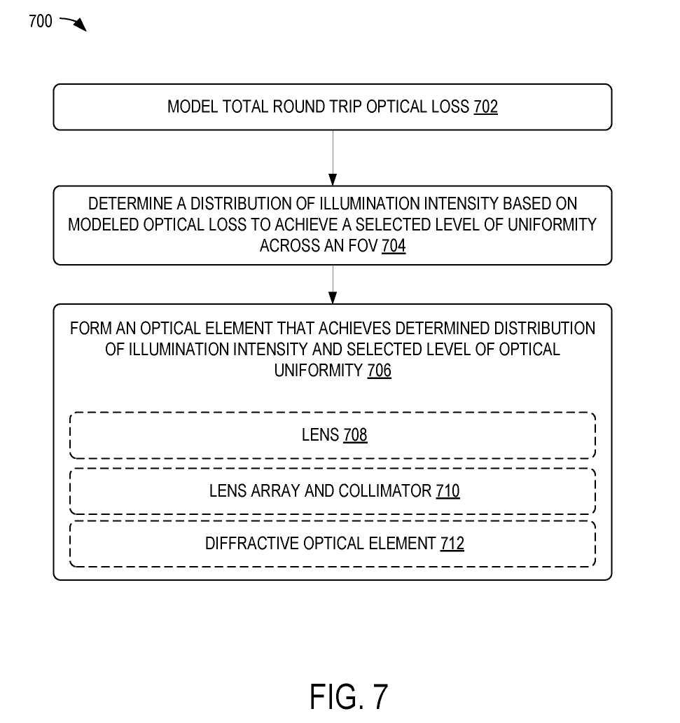

FIG. 7 shows an example method 700 for designing and manufacturing an illumination optic for an illumination system of an image capture device. Method 700 may be used to form illumination optic 300 of FIG. 3, as an example. At 702, the method includes modeling total optical loss for a round trip of light traveling from the illumination source to an object in an environment of the illumination system, and being reflected back to an image sensor of the image capture device. At 704, the method includes determining a distribution of illumination intensity for the illumination source, based at least upon the modeled total optical loss, to achieve a selected level of optical uniformity across a field of view of the illumination system on the round trip of the light.

At 706, the method includes forming an optical element to modify an illumination profile of light output by an illumination source to achieve the determined distribution of illumination intensity and the selected level of optical uniformity. For example, the optical element may include a lens (e.g., a freeform doublet lens), as indicated at 708. As another example the optical element may include a multi-lens array and/or a collimator, as indicated at 710 (e.g., where the illumination source includes a multimode laser diode). As yet another example, the optical element may include a diffractive optical element, as indicated at 712 (e.g., where the illumination source includes a single mode laser diode).

An optical element formed as described herein provides a rectangular illumination profile for image capture systems that may avoids the light intensity roll-off experienced by other illumination sources (e.g., illumination sources without additional optics or with only spherical lenses controlling light emission). The optical element described herein also helps to compensate for the total optical losses experienced along a round trip optical path of emitted illumination light that is reflected off of objects in the environment and detected by an image sensor. The illumination source described herein, including the optics that modify the illumination profile, may thereby output light with a distribution of intensity that has lower intensity at a normal direction compared to intensity at higher angles, such that light arriving at the image sensor has a flatter and more uniform profile than it would if the optical element were not used.

In some embodiments, the methods and processes described herein may be tied to a computing system of one or more computing devices. In particular, such methods and processes may be implemented as a computer-application program or service, an application-programming interface (API), a library, and/or other computer- program product.

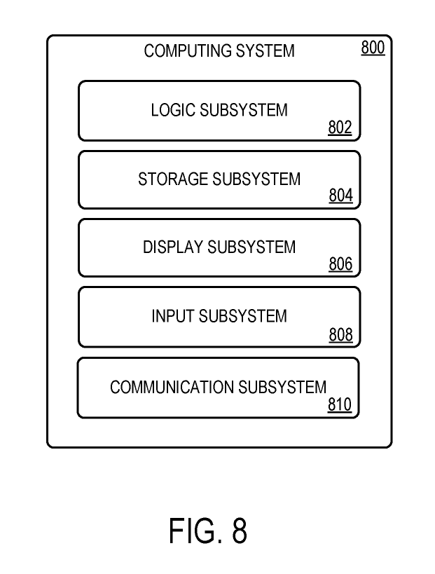

FIG. 8 schematically shows a non-limiting embodiment of a computing system 800 that can enact one or more of the methods and processes described above. Computing system 800 is shown in simplified form. Computing system 800 may take the form of one or more personal computers, server computers, tablet computers, home-entertainment computers, network computing devices, gaming devices, mobile computing devices, mobile communication devices (e.g., smart phone), and/or other computing devices. For example, computing system 800 may be an example of computing device 102 of FIG. 1.

Computing system 800 includes a logic machine 802 and a storage machine 804. Computing system 800 may optionally include a display subsystem 806, input subsystem 808, communication subsystem 810, and/or other components not shown in FIG. 8.

Logic machine 802 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 804 includes one or more physical devices configured to hold instructions executable by the logic machine to implement the methods and processes described herein. When such methods and processes are implemented, the state of storage machine 804 may be transformed—e.g., to hold different data.

Storage machine 804 may include removable and/or built-in devices. Storage machine 804 may include optical memory (e.g., CD, DVD, HD-DVD, Blu-Ray

Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 804 may include volatile, nonvolatile, dynamic, static, read/write, read-only, random-access, sequential-access, location-addressable, file-addressable, and/or content-addressable devices.

It will be appreciated that storage machine 804 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 802 and storage machine 804 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

When included, display subsystem 806 may be used to present a visual representation of data held by storage machine 804. This visual representation may take the form of a graphical user interface (GUI). As the herein described methods and processes change the data held by the storage machine, and thus transform the state of the storage machine, the state of display subsystem 806 may likewise be transformed to visually represent changes in the underlying data. Display subsystem 806 may include one or more display devices utilizing virtually any type of technology. Such display devices may be combined with logic machine 802 and/or storage machine 804 in a shared enclosure, or such display devices may be peripheral display devices.

When included, input subsystem 808 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 810 may be configured to communicatively couple computing system 800 with one or more other computing devices. Communication subsystem 810 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 800 to send and/or receive messages and/or captured images to and/or from other devices via a network such as the Internet.

Another example provides an illumination system including an illumination source configured to output light according to an illumination profile representing a distribution of light intensity across a field of view of the illumination system, an image sensor configured to detect light output by the illumination source and reflected off of one or more objects in an environment of the illumination system, and an illumination optic configured to direct light from the illumination source outward into the environment, the illumination optic structured to form a modified illumination profile having a modified distribution of illumination intensity, the modified distribution of intensity including a first intensity at a normal angle relative to the illumination source and a second intensity at other angles relative to the illumination source, the first intensity being lower than the second intensity. In such an example, the illumination source may additionally or alternatively include a light emitting diode (LED) and the illumination optic may additionally or alternatively include a freeform doublet lens. In such an example, the illumination source may additionally or alternatively include a multimode laser diode and the illumination optic may additionally or alternatively include multi-lens array. In such an example, the illumination source may additionally or alternatively include a single mode laser diode and the illumination optic may additionally or alternatively include a diffractive optical element. In such an example, the image sensor may additionally or alternatively include a visible light camera and the illumination source may additionally or alternatively include one or more visible light sources. In such an example, the image sensor may additionally or alternatively include a depth camera and the illumination source may additionally or alternatively include one or more infrared or visible light sources. In such an example, the modified illumination profile may additionally or alternatively include a bimodal illumination profile. In such an example, the modified distribution of illumination intensity may additionally or alternatively be configured to present a level of optical uniformity presented at the image sensor that is at least 30% uniform across a field of view of the image sensor. In such an example, the modified distribution of illumination intensity may additionally or alternatively be configured to compensate for at least half of the total optical losses experienced by light traveling from the illumination source to the one or more objects in the environment and to the image sensor. Any or all of the above-described examples may be combined in any suitable manner in various implementations.

Another example provides a method of manufacturing an illumination optic for an illumination system of an image capture device, the method including modeling total optical loss for a round trip of light traveling from the illumination source to an object in an environment of the illumination system, and reflected back to an image sensor of the image capture device, determining a distribution of illumination intensity for the illumination source, based at least upon the modeled total optical loss, to achieve a selected level of optical uniformity across a field of view of the illumination system on the round trip of the light, and forming an optical element that achieves the determined distribution of illumination intensity and the selected level of optical uniformity, the optical element being positioned to direct light from the illumination source outward toward the environment of the illumination system. In such an example, the optical element may additionally or alternatively include one or more of a collimating lens, a microlens array, and a diffractive optical element. In such an example, forming the optical element may additionally or alternatively include forming a doublet lens. In such an example, the distribution of illumination intensity may additionally or alternatively include a first intensity at a normal angle relative to the illumination source and a second intensity at other angles relative to the illumination source, the first intensity being lower than the second intensity. In such an example, the determined distribution of illumination intensity may additionally or alternatively be configured to compensate for at least half of the modeled total optical loss. In such an example, the selected level of optical uniformity may additionally or alternatively be based on a field of view of the image sensor. In such an example, the selected level of optical uniformity as measured at the sensor may additionally or alternatively be at least 30%. Any or all of the above-described examples may be combined in any suitable manner in various implementations.

Another example provides a computing device including an image capture device, the image capture device including an illumination source, an image sensor, and an illumination optic positioned over the illumination source, the illumination optic structured to form a modified illumination profile having a modified distribution of illumination intensity, the modified distribution of intensity including a first intensity at a normal angle relative to the illumination source and a second intensity at other angles relative to the illumination source, the first intensity being lower than the second intensity, a display device, a processor, and a storage device storing instructions executable by the processor, the instructions including instructions to output light via the illumination source according to an illumination profile, the illumination profile representing a distribution of light intensity across a field of view of the image capture device, instructions to process light detected by the image sensor to generate a captured image, the light detected by the image sensor including light output by the illumination source and reflected off of one or more objects in the environment, and instructions to display content based at least on the image captured by the image capture device. In such an example, the instructions may additionally or alternatively further include instructions to authenticate a user based at least on the image captured by the image capture device. In such an example, the modified illumination profile may additionally or alternatively include a bimodal illumination profile configured to compensate for at least half of the total optical losses along a light path from the illumination source, to the environment, and from the environment to the image sensor. In such an example, the image capture device may additionally or alternatively include a depth camera. Any or all of the above-described examples may be combined in any suitable manner in various implementations.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. An illumination system comprising:
an illumination source configured to output light according to an illumination profile representing a distribution of light intensity across a field of view of the illumination system;
an image sensor configured to detect light output by the illumination source and reflected off of one or more objects in an environment of the illumination system; and
an illumination optic configured to direct light from the illumination source outward into the environment, the illumination optic structured to form a modified illumination profile having a modified distribution of illumination intensity, the modified distribution of intensity including a first intensity at a normal angle relative to the illumination source and a second intensity at other angles relative to the illumination source, the first intensity being lower than the second intensity.

2. The illumination system of claim 1, wherein the illumination source includes a light emitting diode (LED) and the illumination optic includes a freeform doublet lens.

3. The illumination system of claim 1, wherein the illumination source includes a multimode laser diode and the illumination optic includes a multi-lens array.

4. The illumination system of claim 1, wherein the illumination source includes a single mode laser diode and the illumination optic includes a diffractive optical element.

5. The illumination system of claim 1, wherein the image sensor includes a visible light camera and the illumination source includes one or more visible light sources.

6. The illumination system of claim 1, wherein the image sensor includes a depth camera and the illumination source includes one or more infrared or visible light sources.

7. The illumination system of claim 1, wherein the modified illumination profile comprises a bimodal illumination profile.

8. The illumination system of claim 7, wherein the modified distribution of illumination intensity is configured to present a level of optical uniformity presented at the image sensor that is at least 30% uniform across a field of view of the image sensor.

9. The illumination system of claim 7, wherein the modified distribution of illumination intensity is configured to compensate for at least half of the total optical losses experienced by light traveling from the illumination source to the one or more objects in the environment and to the image sensor.

10. A method of manufacturing an illumination optic for an illumination system of an image capture device, the method comprising:
modeling total optical loss for a round trip of light traveling from the illumination source to an object in an environment of the illumination system, and reflected back to an image sensor of the image capture device;
determining a distribution of illumination intensity for the illumination source, based at least upon the modeled total optical loss, to achieve a selected level of optical uniformity across a field of view of the illumination system on the round trip of the light; and
forming an optical element that achieves the determined distribution of illumination intensity and the selected level of optical uniformity, the optical element being positioned to direct light from the illumination source outward toward the environment of the illumination system.

11. The method of claim 10, wherein the optical element includes one or more of a collimating lens, a microlens array, and a diffractive optical element.

12. The method of claim 11, wherein forming the optical element includes forming a doublet lens.

13. The method of claim 10, wherein the distribution of illumination intensity includes a first intensity at a normal angle relative to the illumination source and a second intensity at other angles relative to the illumination source, the first intensity being lower than the second intensity.

14. The method of claim 10, wherein the determined distribution of illumination intensity is configured to compensate for at least half of the modeled total optical loss.

15. The method of claim 10, wherein the selected level of optical uniformity is based on a field of view of the image sensor.

16. The method of claim 10, wherein the selected level of optical uniformity as measured at the sensor is at least 30%.

17. A computing device comprising:
an image capture device, the image capture device comprising
an illumination source,
an image sensor, and
an illumination optic positioned over the illumination source, the illumination optic structured to form a modified illumination profile having a modified distribution of illumination intensity, the modified distribution of intensity including a first intensity at a normal angle relative to the illumination source and a second intensity at other angles relative to the illumination source, the first intensity being lower than the second intensity;
a display device;
a processor; and
a storage device storing instructions executable by the processor, the instructions including
instructions to output light via the illumination source according to an illumination profile, the illumination profile representing a distribution of light intensity across a field of view of the image capture device,
instructions to process light detected by the image sensor to generate a captured image, the light detected by the image sensor including light output by the illumination source and reflected off of one or more objects in the environment, and
instructions to display content based at least on the image captured by the image capture device.

18. The computing device of claim 17, wherein the instructions further include instructions to authenticate a user based at least on the image captured by the image capture device.

19. The computing device of claim 17, wherein the modified illumination profile comprises a bimodal illumination profile configured to compensate for at least half of the total optical losses along a light path from the illumination source, to the environment, and from the environment to the image sensor.

20. The computing device of claim 17, wherein the image capture device comprises a depth camera.
